(19) United States
(12) Patent Application Publication
(10) Pub. No.: US 2008/0073259 A1
(43) Pub. Date: Mar. 27, 2008

(54) DOSING PIPE DIFFUSER

(76) Inventor: David A. Potts, Killingworth, CT (US)

Correspondence Address: LAW OFFICE OF MICHAEL A. BLAKE, 112 BROAD STREET, MILFORD, CT, 06460, US

(21) Appl. No.: 11/862,371

(22) Filed: Sep. 27, 2007

Related U.S. Application Data
(60) Provisional application No. 60/827,107, filed on Sep. 27, 2006.
(60) Provisional application No. 60/925,241, filed on Apr. 19, 2007.

(51) Int. Cl. C02F 3/20; B05B 1/00

(52) U.S. Cl. 210/170.08; 239/590

(57) ABSTRACT

The disclosed invention relates to a diffuser comprising: a disk, the disk comprising: an inner surface; a first geometric chord; a second geometric chord that is not the first geometric chord, and is parallel to the first geometric chord; a first pipe attachment member extending from the inner surface of the disk, and where the intersection of the first pipe attachment member and the disk lies generally on a first geometric chord of the disk; a second pipe attachment member extending from the inner surface of the disk, and where the intersection of the second pipe attachment member and the disk lies generally on a second geometric chord of the disk; an acute angle α between the first pipe attachment member and the disk, and where the angle α generally faces the second pipe attachment member; an acute angle θ between the second pipe attachment member and the disk, and where the angle θ generally faces the first attachment member; a plurality of slots located on the disk between the first pipe attachment member, and the second pipe attachment member; and a plurality of spacers located on the disk between the first pipe attachment member, and the second pipe attachment member.

### CROSS-REFERENCES

This patent application claims the benefit of provisional patent application Ser. No. 60/827,107 by David A. Potts, entitled “Dosing Pipe Diffuser”, filed on Sep. 27, 2006, the entire contents of which are fully incorporated by reference herein; and also claims the benefit of provisional patent application Ser. No. 60/925,241 by David A. Potts, entitled “Wastewater Distribution System”, filed on Apr. 19, 2007, the entire contents of which are fully incorporated by reference herein.

### TECHNICAL FIELD

The present invention is directed generally to an apparatus for use in subterranean fluid dispensing systems for irrigation and disposal of water and wastewater. The invention is particularly directed to an apparatus for diffusing fluid leaving an outlet orifice of a subterranean water dispensing system, and for inhibiting material from clogging the outlet orifice. Such material includes manmade media, such as but not limited to rubber, polystyrene aggregate, rubber aggregate, and other media such as but not limited to rocks, stones, pebbles and gravel.

### BACKGROUND

Subterranean water dispensing systems typically do not dispense water into the surrounding material on a continuous basis. Instead, the dispensing systems are typically called upon only periodically to dispense such water. During the time when water is not being dispensed, the material surrounding the dispensing system experiences a hydraulic relaxation during which time particulate materials may migrate toward openings or orifices used in the system to dispense the wastewater and may plug or at least inhibit the flow through such openings or orifices.

This problem has been recognized previously and a number of solutions have been proposed.

The preferred water dispensing systems are constructed from substantially continuous pipes or tubes having a plurality of openings or orifices dispersed at spaced intervals along the length of the pipes or tubes. Sleeves or casings have been employed to protect the openings or orifices from being clogged by the surrounding material. The sleeves often have to be slipped or threaded onto the end of the pipe or tube, and then moved along until aligned with the orifice to be protected. The assembly process for such an arrangement is very time-consuming, and therefore undesirable.

To avoid the threading operation, some orifice protectors have been designed to merely sit on to of the pipe or tube over the orifice to be protected. However, such orifice protectors are easily disturbed from their desired location during the back-filling operation, and are nearly impossible to use in circumstances where the orifices of the pipe or tube are located on the bottom or side of the pipe or tube. These orifice protectors can work on the bottom of a pipe, but the orifice protectors are prone to shifting and allowing gravel and other media to migrate and block the orifice.

A more suitable protector for such orifices can be placed at any location along the length of a pipe or tube, and protects a dispensing opening in the tube or pipe regardless of its orientation. Such prior art protectors often require the use of pins to secure the protector in position relative to the pipe which leads to a time-consuming assembly of the system as a whole.

Additionally, there is a need to diffuse the stream of fluid exiting the outlet orifices of the continuous pipes or tubes. These pipes or tubes, often referred to as dosing tubes and/or distribution pipes, may be surrounded and/or enclosed by a geonet which may be obtained from various manufacturers, such as, but not limited to: Grasspave2, Gravelpave2, Rainstore2, Slopetame2, Draincore2, Surefoot4, Rainstore3 from Invisible Structures, Inc., 1600 Jackson Street, Suite 310, Golden, Colo. 80401; Advanedge® flat pipe from Advanced Drainage Systems, Inc. 4640 Trueman Boulevard, Hilliard, Ohio 43026; and Enkadrain drainage system from Colbond Inc., P.O. Box 1057, Enka, N.C. 28728. Direct flow of fluid from the orifice into the geonet may damage the geonet, and the soil beyond the geonet thus, a diffuser is desirable to generally prevent direct impingement of fluid into the geonet.

Thus, there is a need for a diffuser that could be easily added at any point along the dispensing pipe or tube without the need to thread the diffuser on from an end of the pipe or tube, would remain fixed relative to the pipe or tube once placed in the desired relation relative to an orifice in the dispensing tube or pipe, and consisted essentially of a single element which can be fabricated prior to field installation.

### SUMMARY

The disclosed invention relates to a diffuser comprising: a disk, the disk comprising: an inner surface; a first geometric chord; a second geometric chord that is not the first geometric chord, and is parallel to the first geometric chord; a first pipe attachment member extending from the inner surface of the disk, and where the intersection of the first pipe attachment member and the disk lies generally on a first geometric chord of the disk; a second pipe attachment member extending from the inner surface of the disk, and where the intersection of the second pipe attachment member and the disk lies generally on a second geometric chord of the disk; an acute angle α between the first pipe attachment member and the disk, and where the angle α generally faces the second pipe attachment member; an acute angle θ between the second pipe attachment member and the disk, and where the angle θ generally faces the first attachment member; a plurality of slots located on the disk between the first pipe attachment member, and the second pipe attachment member; and a plurality of spacers located on the disk between the first pipe attachment member, and the second pipe attachment member.

The disclosed invention also relates to a septic distribution system comprising: a dosing pipe with orifices located its length; a diffuser attached to the dosing pipe, the diffuser comprising: a disk, the disk comprising: an inner surface; a first geometric chord; a second geometric chord that is not the first geometric chord, and is parallel to the first geometric chord; a first pipe attachment member extending from the inner surface of the disk, and where the intersection of the first pipe attachment member and the disk lies generally on a first geometric chord of the disk; a second pipe attachment member extending from the inner surface of the disk, and where the intersection of the second pipe attachment member and the disk lies generally on a second geometric chord of the disk; an acute angle α between the first pipe attachment member and the disk, and where the angle α generally faces the second pipe attachment member; an acute angle θ between the second pipe attachment member and the disk, and where the angle θ generally faces the first attachment member; a plurality of slots located on the disk between the first pipe attachment member, and the second pipe attachment member; a plurality of spacers located on the disk between the first pipe attachment member, and the second pipe attachment member; and wherein the diffuser is attached to the dosing pipe via an attachment means selected from the group consisting of solvent welding and thermowelding.

In addition, the disclosed invention relates to a septic distribution system comprising: a septic distribution pipe with at least one orifice located generally at the bottom of the septic distribution pipe; a dosing pipe with orifices located its length, the dosing pipe located within the septic distribution pipe; a diffuser attached to the dosing pipe, the diffuser comprising: a disk, the disk comprising: an inner surface; a first geometric chord; a second geometric chord that is not the first geometric chord, and is parallel to the first geometric chord; a first pipe attachment member extending from the inner surface of the disk, and where the intersection of the first pipe attachment member and the disk lies generally on a first geometric chord of the disk; a second pipe attachment member extending from the inner surface of the disk, and where the intersection of the second pipe attachment member and the disk lies generally on a second geometric chord of the disk; an acute angle α between the first pipe attachment member and the disk, and where the angle α generally faces the second pipe attachment member; an acute angle θ between the second pipe attachment member and the disk, and where the angle θ generally faces the first attachment member; a plurality of slots located on the disk between the first pipe attachment member, and the second pipe attachment member; a plurality of spacers located on the disk between the first pipe attachment member, and the second pipe attachment member; and wherein the diffuser disk lies in the bottom half of the septic distribution pipe, with the bottom of the diffuser raised a distance D_{BOT} from the bottom of the septic distribution pipe.

Also, the disclosed invention relates to a water distribution system comprising: a water distribution pipe with at least one orifice located generally at the bottom of the water distribution pipe; a dosing pipe with orifices located along its length, the dosing pipe located within the water distribution pipe; a device that holds the dosing pipe at a distance DBOT above the bottom of the water distribution pipe.

Additionally, the disclosed invention relates to a method of attaching a transparent diffuser onto a dosing pipe, the method comprising: snapping the transparent diffuser onto the dosing pipe; sliding the transparent diffuser on the dosing pipe until it is at generally the same longitude as an orifice on the dosing pipe; rotating the transparent diffuser until one can see the orifice through the transparent diffuser.

Furthermore, the disclosed invention also relates to a water distribution system comprising: a dosing pipe with orifices located along its length; a diffuser permanently and rigidly attached to the dosing pipe, the diffuser comprising: a disk; and a dosing pipe attachment means extending from the disk.

The disclosed invention, in addition, relates to a diffuser comprising: a disk with rounded surfaces; a dosing pipe attachment means extending from the disk, the attachment means having rounded surfaces; and wherein the rounded surfaces of the disk and the attachment means are configured to refrain from snagging.

### BRIEF DESCRIPTION OF THE FIGURES

The present disclosure will be better understood by those skilled in the pertinent art by referencing the accompanying drawings, where like elements are numbered alike in the several figures, in which:

FIG. 1 is a perspective view of the disclosed diffuser;

FIG. 2 is a top view of the diffuser;

FIG. 3 is a bottom view of the diffuser;

FIG. 4 is a side view of the diffuser;

FIG. 5 is a front view of the diffuser;

FIG. 6 is perspective view of the diffuser installed on a dosing tube;

FIG. 7 is a cross-sectional view of the diffuser;

FIG. 8 is a perspective view of the diffuser installed on a dosing tube, within a septic system distribution pipe;

FIG. 9 is a front view of the diffuser installed on a dosing tube, within a septic system distribution pipe;

FIG. 10 is a perspective view of the diffuser installed on a dosing tube, within a septic system distribution pipe, the septic distribution pipe within a low aspect ratio conduit.

### DETAILED DESCRIPTION

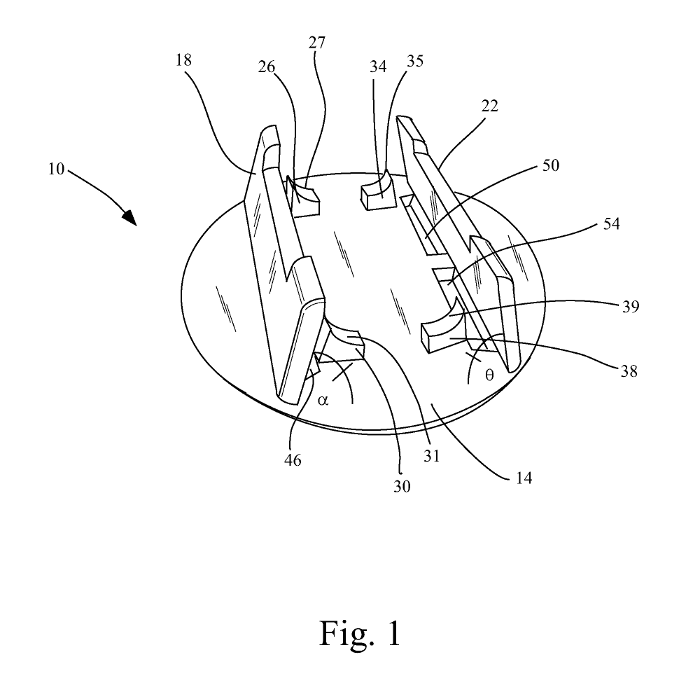

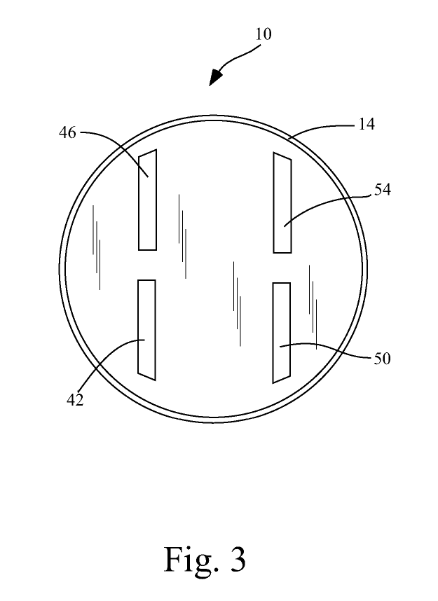

FIG. 1 shows a perspective view of the disclosed diffuser 10. A disk 14 is shown with a first pipe attaching member 18, and a second pipe attachment member 22. The pipe attaching members 18, 22 extend from the disk at an angle α and an angle θ, respectively, where a is less than about 90° and θ is less than about 90°. Four spacers 26, 30, 34, 38 are located on the disk 14 and within the boundaries of the two pipe attachment members 18, 22. Each of the spacers 26, 30, 34, 38 have a curved surface (27, 31, 35, and 39 respectively) configured to generally fit against the curved surface of a dosing pipe. A plurality of slots is located on the disc 14. In this embodiment, four (4) slots 42, 46, 50, 54 are located on the disk, within the boundaries of the two pipe attaching members 18, 22, and all four slots are generally parallel to the length of the two pipe attaching members 18, 22. In this view, slots 42, 46 are obstructed by pipe attaching members 18, but will be seen more clearly in FIG. 3. One of ordinary skill in the art will recognize that the slots may be replaced by openings of nearly any shape, and the number of openings/slots may vary from one (1) to four (4) or more.

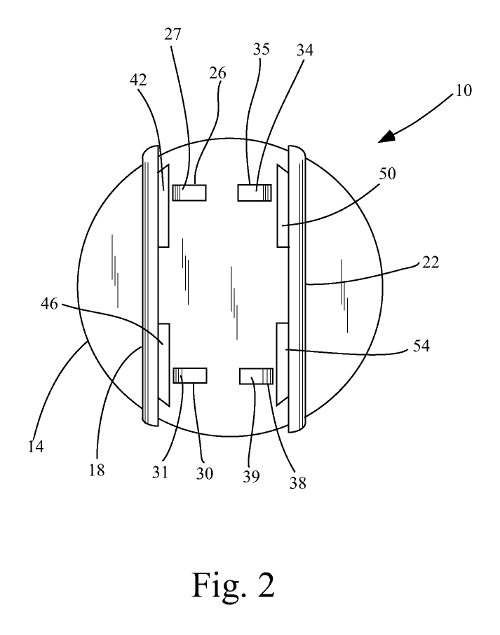

FIG. 2 is a top view of the diffuser 10, looking down on the two pipe attaching members 18, 22 extending from the disk 14. FIG. 3 is a bottom view of the diffuser 10; the pipe attaching members 18, 22 are on the other side of the disk 14. In FIG. 3 the four (4) slots 42, 46, 50, 54 are clearly visible.

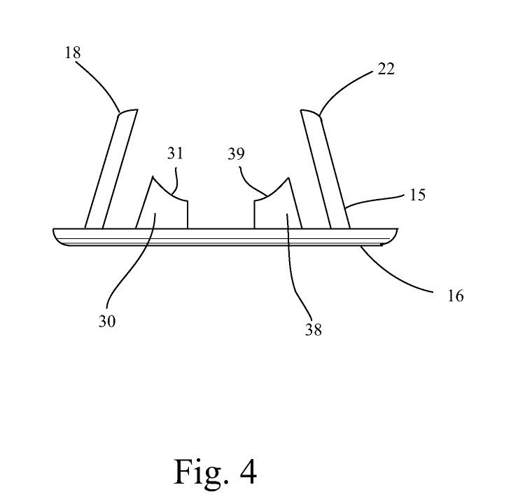

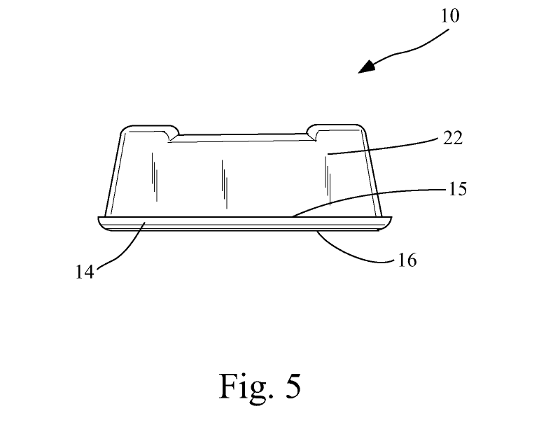

FIG. 4 is a side view of the diffuser 10, looking generally along the pipe attaching members 18, 22. The disk has an inner surface 15 and an outer surface 16. FIG. 5 is a side view of the diffuser 10, looking generally in a direction orthogonal to the pipe attaching members 18, 22.

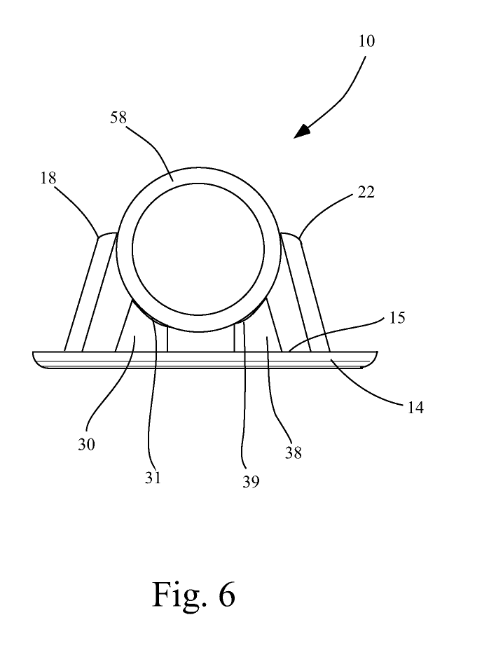

FIG. 6 is a perspective view of the diffuser 10 installed on a piece of dosing tube 58. In this view, it can be seen that the spacers 30 and 38 fit generally flush against the outer surface of the dosing tube 58, due to the curved surfaces 31, 39. Although not seen in this view, spacers 26, and 34 fit similarly against the outer surface of the dosing tube 58.

When installing the disclosed diffuser 10 onto a dosing tube, the diffuser 10 simply snaps onto the dosing tube 58, due to the slightly flexible nature of pipe attaching members 18, 22, which will expand slightly to accommodate the dosing tube 58, and hold the dosing tube 58 in place against the spacers 26, 30, 34, 38. The diffuser will be positioned so that center of the inner surface 15 of the disk 14 will be generally adjacent to the orifice of the dosing pipe 58. The diffuser 10 may then be attached. If the diffuser and dosing tube are made out of PVC, then the attachment means may be “solvent welding” with a primer to soften and a glue to bond. This is a known attachment means for PVC pipes and accessories. If the diffuser and dosing pipe are made out of Polyethylene, then the attachment means may be thermowelding. In this configuration, the outer surface 16 of the disk 14 will generally face a downward direction (i.e. towards the center of the earth). Thus when fluid leaves the dosing pipe 58, it impinges the inner surface 15 of the disk 14, and the fluid either flows down the slots 42, 46, 50, 54, or over the edge of the disk 14. Of course, in other configurations, the outer surface 16 of the disk may generally face an upward direction, depending on the needs of the user, and the constraints of the water distribution system.

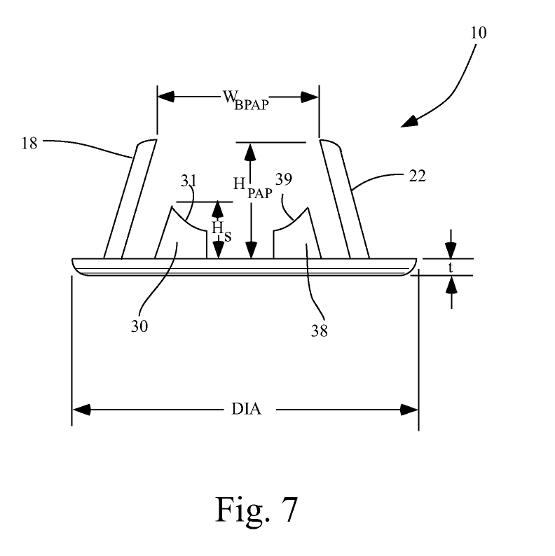

The diffuser will be made out of a slightly flexible material which allows the pipe attaching members 18, 22 to flex outward in order to allow the diffuser 10 to snap onto a dosing pipe 58 via an interference fit. Some materials the diffuser may be made out of include, but are not limited to: PVC, polyethylene, and stainless steel. Referring now to FIG. 7, which is a cross-sectional view of the diffuser through spacers 30, 38. In one embodiment, if the diffuser 10 were to be used on a PVC dosing pipe with an inner diameter of about 1 inch, the diameter “DIA” of the diffuser 10 may be about 3.5 inches, the height “H_{PAP}” of the pipe attaching members 18, 22 may be about 14/16 of an inch, the height of spacers “H_{S}” may be about 7/16 of an inch, and the distance “W_{BPAP}” between the pipe attaching members 18, 22 may be about 1 and ¼ inches. The thickness of the diffuser “t” may be generally about ⅛ of an inch. These dimensions may be scaled up or down depending on the size of the dosing pipe. The thickness “t” may or may not be scaled to the size of the dosing pipe. The dimensions of the diffuser may vary, but the general idea is to prevent stone, aggregate, particulates and other media, etc. from reaching the orifice(s) of the dosing pipe. If the surrounding particulate matter is larger, then the diffuser shield may be sized larger. The round shape of the disk 14 is intended to allow the dosing pipe diffuser 10 to slide through geonet (and/or other materials) smoothly. The diffuser is smooth and rounded to not cut or rip the geonet or geotextile fabrics during installation and/or removal. That is, there are no sharp edges or sharp protrusions on the diffuser 10 that will cut or snag or catch onto a geonet or geotextile fabric. The flat plane shape of the disk 14 is intended to help maintain the orientation of the diffuser plate to the orifices, that is, it helps prevents the dosing pipe diffuser 10 from rolling over during construction of the water distribution system. In addition, the diffuser may be made out of a transparent material. A transparent diffuser will allow an installer to place the diffuser on a dosing pipe (or any pipe with orifices) and locate an orifice on the dosing pipe with respect to the diffuser, such that the diffuser may be placed directly over an orifice so that the orifice is centered on the diffuser (or the orifice may be purposefully placed off-center with respect to the diffuser). In other words, when an installer is installing a diffuser on a dosing pipe, the installer can locate the proper position of the diffuser, by looking through the transparent diffuser, and when he sees that the diffuser is directly over an orifice (which he can see through the transparent diffuser), then the installer knows he has properly located the diffuser.

The diffuser 10 so far described is also useful in a slightly different application as well. Pressure distribution allows for the wastewater to be more evenly applied to a stone and pipe, plastic or concrete chambers, or other leach field, than is possible with gravity. This diffuser and associated piping serves to further improve on the benefits of pressure distribution.

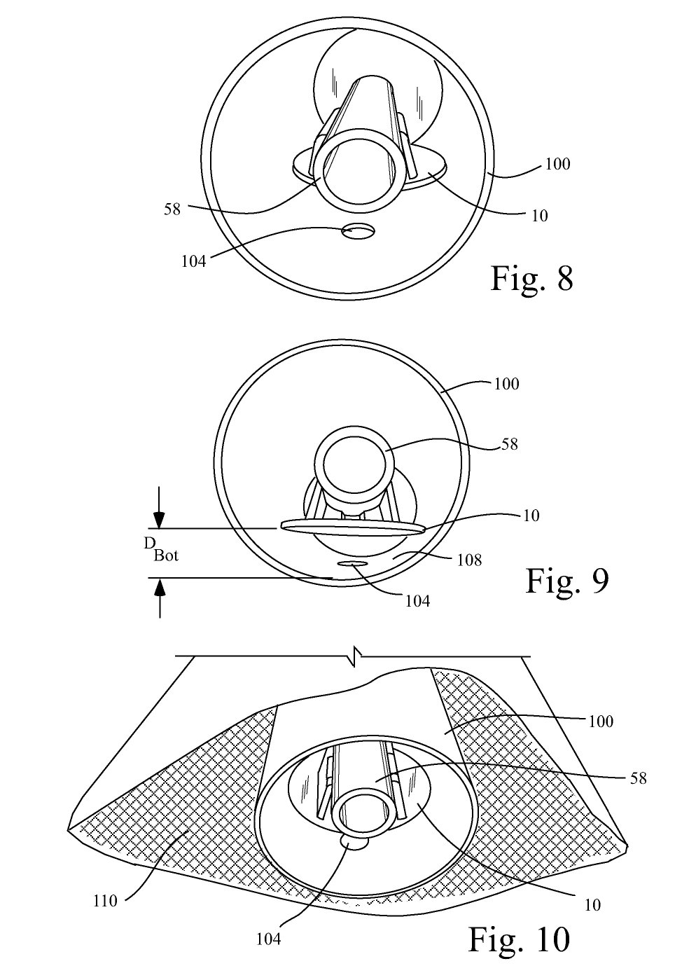

The diffuser 10 can be designed to fit down a typical 4″ septic system distribution pipe 100, as shown in FIG. 8, which is a perspective view of a septic system distribution pipe 100 with a dosing pipe 58 located inside of it, and a diffuser 10 attached to the dosing pipe 58. In this mode of operation, the diffuser is typically installed on a 1″ pipe or dosing tube 58 or hose, with the desired size and spacing of orifice holes. This entire assembly can then be fed/slid down a typical 4″ leach field pipe 100 if desired. A generally front view of this assembly is shown in FIG. 9.

The diffuser rests generally in the bottom half of the 4″ pipe 100, but does not touch the pipe 100 at the 6 o'clock position of the pipe 100. FIG. 9 shows how the diffuser 10 holds the dosing tube 58 above the bottom 108 of the septic distribution pipe 100. The diffuser 10 maintains a space between the bottom of the diffuser 10 and the bottom 108 of the septic distribution pipe 100. The space is shown in FIG. 9 as D_{BOT}. For a 4 inch septic distribution pipe 100, and a one inch dosing tube 58, D_{BOT} may be about 0.5 inches to about 1.25 inches. This ensures that the orifice holes in the dosing tube 58 and any orifice holes 104 in the septic pipe 100 are not blocked by dosing tube 58 lying against the bottom of the leach field pipe 100. This configuration also helps prevents any sludge that has accumulated in the bottom of the septic pipe 100 from being stirred up by the high velocity water exiting the orifice of the dosing tube 58. This is particularly helpful with typical 4″ septic distribution pipes 100, since holes 104 may not be directly in the bottom of the pipe, at 6 o'clock, but rather at 5 and 7 o'clock, retaining sludge and water below the holes and above the invert of the pipe.

In one preferred embodiment, the diffuser 10 described above is used in conjunction with a 4″ pipe 100 with holes 104 located along the bottom of the pipe 100 at the 6 o'clock position. This serves to most accurately distribute the wastewater without allowing sludge and water to be retained in the bottom of the pipe 100 as is the case with prior art septic pipes with holes at 5 and 7 o'clock.

With this new diffuser system, it is also possible to retrofit a traditional gravity based leach field with pressure dosing, without digging up the system, by sliding the assembly down the existing 4″ pipe 100.

These orifice and piping embodiments are also well suited to all pressure distribution applications for wastewater, such as with low pressure pipe systems bedded in stone or chamber applications. This concept of a larger pipe 100 with a smaller diffuser 10 outfitted pressure pipe 58 inside, can also be utilized in conjunction with a Low Aspect Ratio Conduit 110, as shown in FIG. 10. The low aspect ratio conduit is described in patent application Ser. No. 11/144,968, entitled “Low aspect ratio wastewater system”, to David A. Potts, and filed on Jun. 3, 2005, the entire contents of which is fully incorporated by reference herein. Thus, in one embodiment the diffuser can used in a septic distribution system comprising: a septic distribution pipe with at least one orifice located generally at the bottom of the septic distribution pipe; a dosing pipe with orifices located its length, the dosing pipe located within the septic distribution pipe; a diffuser attached to the dosing pipe; a low aspect ratio leaching conduit located below the surface of the ground, the leaching conduit comprising: a channel with a top surface and a bottom surface, and with a height and width, wherein the aspect ratio of the channel is given by the height divided by the width; the septic distribution pipe in fluid communication with the channel; and wherein the aspect ratio of the channel is configured to promote aerobic conditions in and around the leaching conduit and the aspect ratio of the channel is less than about 0.2.

In all these embodiments, the smaller pipe 58 could be pulled out of the larger pipe 100, which is contained within the Low Aspect Ratio Conduit 110, stone or a chamber system.

Although described above as a 1″ pressure pipe 58 in a 4″ gravity septic pipe 100, this concept could also be readily adapted for other pipe sizes by scaling the components appropriately.

The disclosed dosing pipe diffuser has many advantages. The dosing pipe diffuser may be permanently affixed to a distribution pipe: The orifice and dosing pipe diffuser maintain their critical respective positions. The distribution pipe is less likely to rotate during construction or backfilling/covering of the system with soil, etc. The dosing pipe diffuser is smooth and rounded to not cut or rip the geonet or geotextile fabrics and to slide down other pipes. That is, there are no sharp edges or sharp protrusions that will cut or snag onto a geonet or geotextile fabric or other pipes. The entire distribution pipe can be fabricated off-site, minimizing debris from entering system and clogging up installation. All supports and slots are sized to prevent stone and other media/material from migrating to the actual orifice and blocking it. The dosing pipe diffuser may be molded or otherwise fabricated out of a clear material so that assembly is simpler. This way you can align the orifice and the dosing pipe diffuser so that the water leaving the orifice impinges on the dosing pipe diffuser. Using the dosing pipe diffuser prevents the material surrounding the shield from being eroded. Since the dosing pipe diffuser may be glued on (solvent welded), the entire distribution pipe can be fabricated off site and transported to the job site with the holes drilled and the dosing pipe diffuser glued on. This saves significant time in the field and minimizes aggregate and debris from getting into the pipe and holes. The orifice holes are typically about ⅛ to about 1/4 inch id. The orifice can also be permanently attached to the distribution pipe to ensure that the orifice is oriented so that the fluid velocity is dissipated against the dosing pipe diffuser and that the piping system can not rotate form the plane it is set on.

The term “water” in this patent application shall include water, clean water, wastewater, stormwater, and reused water, etc. The disclosed dosing pipe diffuser may be used in water systems, and any other fluid distribution system.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A diffuser comprising:
a disk, the disk comprising:
an inner surface;
a first geometric chord;
a second geometric chord that is not the first geometric chord, and is parallel to the first geometric chord;
a first pipe attachment member extending from the inner surface of the disk, and where the intersection of the first pipe attachment member and the disk lies generally on a first geometric chord of the disk;
a second pipe attachment member extending from the inner surface of the disk, and where the intersection of the second pipe attachment member and the disk lies generally on a second geometric chord of the disk;
an acute angle α between the first pipe attachment member and the disk, and where the angle α generally faces the second pipe attachment member;
an acute angle θ between the second pipe attachment member and the disk, and where the angle θ generally faces the first attachment member;
a plurality of slots located on the disk between the first pipe attachment member, and the second pipe attachment member; and
a plurality of spacers located on the disk between the first pipe attachment member, and the second pipe attachment member.

2. The diffuser of claim 1, wherein the each plurality of spacers have a curved surface configured to generally lie flush against a dosing pipe.

3. The diffuser of claim 1, wherein the diffuser is made out of a material selected from the group consisting of PVC, polyethylene, stainless steel, and a transparent plastic.

4. The diffuser of claim 1, wherein the diffuser is configured to attach to a dosing pipe via an interference fit with the first and second pipe attachment members

5. The diffuser of claim 1, wherein the plurality of spacers comprises:
four spacers.

6. The diffuser of claim 1, wherein the acute angle α and an acute angle θ each have a value of between about 70° and about 85°.

7. The diffuser of claim 1, wherein the disk has a diameter of about 3.5 inches, and the height of each of the pipe attachment members relative to the inner surface of the disk is about 14/16 of an inch; and the height of each of the plurality of spacers is about 7/16 of an inch; and the distance between tips of each of the pipe attachment members is about 1 and ¼ inches, and the thickness of the disk is about ⅛ of an inch.

8. The diffuser of claim 1, where the diffuser has rounded edges and no sharp protruding members.

9. A septic distribution system comprising:
a dosing pipe with orifices located along its length;
a diffuser attached to the dosing pipe, the diffuser comprising:
a disk, the disk comprising:
an inner surface;
a first geometric chord;
a second geometric chord that is not the first geometric chord, and is parallel to the first geometric chord;
a first pipe attachment member extending from the inner surface of the disk, and where the intersection of the first pipe attachment member and the disk lies generally on a first geometric chord of the disk;
a second pipe attachment member extending from the inner surface of the disk, and where the intersection of the second pipe attachment member and the disk lies generally on a second geometric chord of the disk;
an acute angle α between the first pipe attachment member and the disk, and where the angle α generally faces the second pipe attachment member;
an acute angle θ between the second pipe attachment member and the disk, and where the angle θ generally faces the first attachment member;
a plurality of slots located on the disk between the first pipe attachment member, and the second pipe attachment member;
a plurality of spacers located on the disk between the first pipe attachment member, and the second pipe attachment member; and
wherein the diffuser is attached to the dosing pipe via an attachment means selected from the group consisting of solvent welding and thermowelding.

10. A septic distribution system comprising:
a septic distribution pipe with at least one orifice located generally at the bottom of the septic distribution pipe;
a dosing pipe with orifices located along its length, the dosing pipe located within the septic distribution pipe;
a diffuser attached to the dosing pipe, the diffuser comprising:
a disk, the disk comprising:
an inner surface;
a first geometric chord;
a second geometric chord that is not the first geometric chord, and is parallel to the first geometric chord;
a first pipe attachment member extending from the inner surface of the disk, and where the intersection of the first pipe attachment member and the disk lies generally on a first geometric chord of the disk;
a second pipe attachment member extending from the inner surface of the disk, and where the intersection of the second pipe attachment member and the disk lies generally on a second geometric chord of the disk;
an acute angle α between the first pipe attachment member and the disk, and where the angle α generally faces the second pipe attachment member;
an acute angle θ between the second pipe attachment member and the disk, and where the angle θ generally faces the first attachment member;
a plurality of slots located on the disk between the first pipe attachment member, and the second pipe attachment member;
a plurality of spacers located on the disk between the first pipe attachment member, and the second pipe attachment member; and
wherein the diffuser disk lies in the bottom half of the septic distribution pipe, with the bottom of the diffuser raised a distance D_{BOT} from the bottom of the septic distribution pipe.

11. The septic distribution system of claim 10,
wherein the septic distribution pipe has an inner diameter of about 4 inches, and the dosing pipe has an inner diameter of about 1 inch.

12. The septic distribution system of claim 11, wherein D_{BOT} is between about 0.5 inches and 1.25 inches.

13. The septic distribution system of claim 10 further comprising:
a low aspect ratio leaching conduit located below the surface of the ground, the leaching conduit comprising:
a channel with a top surface and a bottom surface, and with a height and width, wherein the aspect ratio of the channel is given by the height divided by the width;
the septic distribution pipe in fluid communication with the channel; and
wherein the aspect ratio of the channel is configured to promote aerobic conditions in and around the leaching conduit and the aspect ratio of the channel is less than about 0.2.

14. A water distribution system comprising:
a water distribution pipe with at least one orifice located generally at the bottom of the water distribution pipe;
a dosing pipe with orifices located along its length, the dosing pipe located within the water distribution pipe;
a device that holds the dosing pipe at a distance D_{BOT} above the bottom of the water distribution pipe.

15. A method of attaching a transparent diffuser onto a dosing pipe, the method comprising:
snapping the transparent diffuser onto the dosing pipe;
sliding the transparent diffuser on the dosing pipe until it is at generally the same longitude as an orifice on the dosing pipe;
rotating the transparent diffuser until one can see the orifice through the transparent diffuser.

16. The method of claim 15, further comprising:
rotating and sliding the transparent diffuser until one can see, through the transparent diffuser, that the orifice is generally centered with respect to the transparent diffuser;
attaching, permanently, the transparent diffuser to the dosing pipe.

17. The method of claim 16, wherein the attaching step comprises:
gluing the transparent diffuser to the dosing pipe.

18. A water distribution system comprising:
a dosing pipe with orifices located along its length;
a diffuser permanently and rigidly attached to the dosing pipe, the diffuser comprising:
a disk; and
a dosing pipe attachment means extending from the disk.

19. A diffuser comprising:
a disk with rounded surfaces;
a dosing pipe attachment means extending from the disk, the attachment means having rounded surfaces; and
wherein the rounded surfaces of the disk and the attachment means are configured to refrain from snagging.
